(19) United States
(12) Patent Application Publication
(10) Pub. No.: US 2025/0273966 A1
(43) Pub. Date: Aug. 28, 2025

(54) SYSTEM AND METHODS FOR ADJUSTING POWER SETPOINTS FOR POWER DEMAND MANAGEMENT

(71) Applicant: Eaton Intelligent Power Limited, Dublin (IE)

(72) Inventors: Shyam Sunder Ramamurthy, Pittsburgh, PA (US); Bruce Gordon Campbell, Warrendale, PA (US); Amit Govind Kolge, Cranberry Township, PA (US)

(21) Appl. No.: 18/588,427

(22) Filed: Feb. 27, 2024

(51) Int. Cl. H02J 3/46; H02J 3/00

(52) U.S. Cl. CPC H02J 3/46; H02J 3/007; H02J 2203/10

(57) ABSTRACT

In one embodiment, a method includes accessing a measurement of power flow on a tie line performed at a pre-determined uniform interval, detecting that a measurement of power flow exceeds a maximum power demand contract at a first time instance, entering into an excess demand compensation mode, where an excess energy demand is controlled to be zero during the excess demand compensation mode, and wherein the excess energy demand at a time instance after the first time instance is calculated based on measurements of power flow on or after the first time instance relative to the maximum power demand contract until the excess energy demand becomes zero, and modifying one or more power setpoints during the excess demand compensation mode to control the excess energy demand to be zero within the pre-determined amount of time from the first time.

### TECHNICAL FIELD

This disclosure generally relates to a control system, and more specifically to a system and methods for meeting the power demand contract, by adjusting power setpoints to compensate excess or deficit energy demand as computed by the disclosure.

### BACKGROUND

An electrical grid is an interconnected network for electricity delivery from producers to consumers. An electrical grid may comprise a utility grid and one or more distributed energy resources (solar panels, wind turbines, generators, energy storages) that provide its power, and one or more loads that consume the power. Electrical grids vary in size. A microgrid is a self-sufficient energy system that serves a discrete geographic footprint, such as a college campus, hospital complex, business center or neighborhood. A microgrid controller may maintain overall system stability regulating power flow and monitoring protection schemes in real-time, while dynamically managing generating assets and loads to meet user defined goals.

### SUMMARY OF PARTICULAR EMBODIMENTS

In particular embodiments, a microgrid controller may adjust power setpoints to meet the power demand contract with the utility grid. Within a microgrid, load excursions may cause the power flow from utility or other tie to exceed a maximum or minimum power demand threshold setting, thereby violating the power demand limit. The legacy microgrid controllers respond to the load excursions as fast as possible by controlling the power flow to the maximum or minimum power threshold and requiring adequate online sources to meet the expected load excursion. Despite the fast response, control of demand power to or below the threshold may not be guaranteed due to lags in the system that are not actively computed and mitigated by the legacy microgrid controllers. The legacy solutions only work when the threshold has been exceeded only for a portion of a demand interval and the power flow falls below the peak threshold, thereby meeting the contract demand. However, in some situations, the load may remain beyond the maximum or minimum power threshold for the entire demand interval. In such situations, an initial error caused by lag in response may not be ever compensated. Sources such as generators and energy storage may be offline or have lags in their response due to ramps, communication and actuation delay. A sudden excursion in load may result in exceeding the contract demand if the control only brings the power flow back to the peak threshold, in which case a penalty would be charged. To cancel the excess energy flow seen during the lag period, the power flow needs to be corrected past the contract demand for at least a part of the demand interval. Furthermore, when multiple sources are available, user would prefer avoiding running of multiple sources unless necessary at the peak load periods.

In electricity measurement, a term “demand” may be used to express average value over an interval. The most common demand interval may be 15 minutes while 30 and 10 minutes are also widely used. Normally demand measurements may be provided for volts, amps, total harmonics and powers. A maximum demand contract may be a maximum amount of average power during a demand interval that a site can consume. When the site consumes more than the maximum demand contract, a penalty will be charged by the utility. A minimum demand contract may be a minimum amount of average power energy during a demand interval that the site should consume. When the site consumes less than the minimum demand contract, another penalty will be charged by the utility. A power setpoint for a source may be a desired or target power from the source, which may differ from an actual real-time measured power provided from the source.

In particular embodiments, a microgrid controller may access a measurement of power flow on a tie line performed at a pre-determined uniform interval. In particular embodiments, the measurement of power flow on the tie line may be performed by a microgrid controller. In particular embodiments, the measurement of power flow on the tie line may be performed by a meter outside a microgrid controller. The microgrid controller may calculate a moving average of the measured power flow over latest N measurements corresponding to a pre-determined amount of time. The pre-determined amount of time may be a demand interval. A penalty may be charged when an average of power flow on the tie line over a demand interval exceeds the maximum power demand contract. For compensating the demand contract violation, this disclosure introduces the term excess energy demand. The excess energy demand is accumulated either by a moving window averaging method or simple integration whenever the power flow exceeds the maximum power demand contract and the accumulation continues as long as the excess energy demand is non-zero even when the power flow falls below the maximum power demand contract. In particular embodiments, the microgrid controller may detect that a measurement of power flow exceeds a maximum power demand contract at a first time instance. The microgrid controller may enter into an excess demand compensation mode in response to the detection that a measurement of power flow exceeds a maximum power demand contract at the first time instance. The microgrid controller may control an excess energy demand to be zero during the excess demand compensation mode. The microgrid controller may calculate the excess energy demand at a time instance after the first time instance based on measurements on or after the first time instance of power flow relative to the maximum power demand contract. The excess demand compensation mode may end when the excess energy demand becomes zero. The microgrid controller may modify one or more power setpoints during the excess demand compensation mode to control the excess energy demand to be zero within the pre-determined amount of time from the first time instance.

In particular embodiments, to modify the one or more power setpoints, the microgrid controller may calculate the excess energy demand at a second time instance by multiplying the pre-determined amount of time to a first moving window average of differences between the measurements on or after the first time instance and the maximum power demand contract at a second time instance. The second time instance may be later than the first time instance and within the pre-determined amount of time from the first time instance. The first moving window average may be calculated over latest N measurements at the second time instance. Measurements before the first time instance among the latest N measurements may be considered as zero. The microgrid controller may access a time clamp value calculated based on a second moving window average at the first time instance of measurements of power flow greater than or equal to a minimum power demand contract. The time clamp value may be in between 0 and the pre-determined amount of time. The microgrid controller may calculate a power compensation time by subtracting a maximum among the time clamp value and an elapsed time since the first time instance from the pre-determined amount of time. The microgrid controller may add an estimated power compensation to a power setpoint for at least one online power generation source. The estimated power compensation may be computed by dividing the excess energy demand calculated at the second time instance by the power compensation time. In particular embodiments, the microgrid controller may determine that a resulting power setpoint after adding the estimated power compensation exceeds a threshold of power capacity of the at least one online power generation source. In response to the determination, the microgrid controller may enable at least one additional power generation source. The microgrid controller may add a portion of the estimated power compensation to a power setpoint for the at least one additional power generation source.

In particular embodiments, to modify the one or more power setpoints to compensate the excess energy demand, the microgrid controller may modify a power setpoint for at least one online power generation source from an initial value to a maximum capacity of the at least one online power generation source. The microgrid controller may calculate an excess energy demand at each time instance accessing the measurement of the power flow on the tie line. The microgrid controller may restore the power setpoint to the initial value when the calculated excess energy demand becomes zero. In particular embodiments, the microgrid controller may determine that modifying the power setpoint for at least one online power generation source to the maximum capacity of the at least one online power generation source is not enough to compensate the excess energy demand within the pre-determined amount of time from the first time instance. In response to the determination, the microgrid controller may enable at least one additional power generation source. The microgrid controller may modify a power setpoint for the at least one additional power generation source to a maximum capacity of the at least one additional power generation source.

In particular embodiments, to modify the one or more power setpoints to compensate the excess energy demand, the microgrid controller may modify a maximum demand setpoint to a value below the maximum demand power contract on the tie line. The microgrid controller may calculate an excess energy demand at each time instance accessing the measurement of the power flow on the tie line. The microgrid controller may restore the maximum demand setpoint to the maximum demand power contract on the tie line when the calculated excess energy demand becomes zero.

In particular embodiments, the microgrid controller may determine reducing loads at a site is allowed when the microgrid controller detects that the calculated moving average exceeds the maximum demand power contract on the tie line. In response to the determination, the microgrid controller may send instructions to reduce loads at the site.

In particular embodiments, the microgrid controller may access a measurement of power flow on the tie line performed at a pre-determined uniform interval. The microgrid controller may calculate a moving average of the measured power flow over latest N measurements corresponding to a pre-determined amount of time. The pre-determined amount of time may be a demand interval. A penalty may be charged when an average of power flow on the tie line over a demand interval falls below the minimum demand contract. For compensating the demand contract violation, this disclosure introduces the term deficit energy demand. The deficit energy demand is accumulated either by a moving window averaging method or simple integration whenever the power flow falls below the minimum power demand contract, and the accumulation continues as long as the deficit energy demand is non-zero even when the power flow increases above the minimum power demand contract. In particular embodiments, the microgrid controller may detect that a measurement of power flow falls below a minimum power demand contract at a first time instance. The microgrid controller may enter into a deficit demand compensation mode in response to the detection that a measurement of power flow falls below a minimum power demand contract. The microgrid controller may control a deficit energy demand to be zero during the deficit demand compensation mode. The microgrid controller may calculate the deficit energy demand at a time instance after the first time instance based on measurements on or after the first time instance of power flow relative to the minimum power demand contract until the deficit energy demand becomes zero. The deficit demand compensation mode may end when the deficit energy demand becomes zero. The microgrid controller may modify one or more power setpoints during the deficit demand compensation mode to control the deficit energy demand to be zero within the pre-determined amount of time from the first time instance.

In particular embodiments, to modify the one or more power setpoints, the microgrid controller may calculate the deficit energy demand at a second time instance by multiplying the pre-determined amount of time to a first moving window average of differences between the measurements on or after the first time instance and the minimum power demand contract. The second time instance may be later than the first time instance and within the pre-determined amount of time from the first time instance. The first moving window average may be calculated over latest N measurements at the second time instance. Measurements before the first time instance among the latest N measurements may be considered as zero. The microgrid controller may access a time clamp value calculated based on a second moving window average at the first time of measurements of power flow less than or equal to a maximum power demand contract. The time clamp value may be in between 0 and the pre-determined amount of time. The microgrid controller may calculate a power compensation time by subtracting a maximum among the time clamp value and an elapsed time since the first time instance from the pre-determined amount of time. The microgrid controller may subtract an estimated power compensation from a power setpoint for at least one online power generation source. The estimated power compensation may be computed by dividing the deficit energy demand at the second time instance by the power compensation time.

In particular embodiments, to modify the one or more power setpoints to compensate the deficit energy demand, the microgrid controller may modify a power setpoint for at least one online power generation source from an initial value to a minimum capacity of the at least one online power generation source. The microgrid controller may calculate a deficit energy demand at each time instance accessing the measurement of the power flow on the tie line. The microgrid controller may restore the power setpoint to the initial value when the calculated deficit energy demand becomes zero.

In particular embodiments, to modify the one or more power setpoints to compensate the deficit energy demand, the microgrid controller may modify a minimum demand setpoint to a value above the minimum demand power contract on the tie line. The microgrid controller may calculate a deficit energy demand at each time instance accessing the measurement of the power flow on the tie line. The microgrid controller may restore the minimum demand setpoint to the minimum demand power contract on the tie line when the calculated deficit energy demand becomes zero.

The embodiments disclosed herein are only examples, and the scope of this disclosure is not limited to them. Particular embodiments may include all, some, or none of the components, elements, features, functions, operations, or steps of the embodiments disclosed herein. Embodiments according to the invention are in particular disclosed in the attached claims directed to a method, a storage medium, a microgrid controller and a computer program product, wherein any feature mentioned in one claim category, e.g. method, can be claimed in another claim category, e.g. microgrid controller, as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1 illustrates an example handling of a load excursion by a legacy microgrid controller shown as a result of a simulation.

FIG. 2A illustrates an example logical architecture of a microgrid, in accordance with certain aspects of the present disclosure.

FIG. 2B illustrates example calculations of moving averages over N samples.

FIG. 3A illustrates example logics to determine an excess energy demand compensation mode and a deficit energy demand compensation mode.

FIG. 3B illustrates particular example logics to calculate an excess energy demand and a deficit energy demand.

FIG. 3C illustrates alternative example logics to calculate an excess energy demand and a deficit energy demand.

FIG. 3D illustrates example logics to calculate an excess time clamp value and a deficit time clamp value.

FIG. 3E illustrates example logics to calculate an excess power compensation time and a deficit power compensation time.

FIG. 4 illustrates an example handling of a load excursion, in accordance with certain aspects of the present disclosure.

FIG. 5 illustrates another example handling of a load excursion, in accordance with certain aspects of the present disclosure.

FIG. 6 illustrates an example method for compensating an excess energy demand by modifying power setpoints.

FIG. 7 illustrates an example method for compensating a deficit energy demand by modifying power setpoints.

FIG. 8 illustrates an example computer system.

### DESCRIPTION OF EXAMPLE EMBODIMENTS

For power demand control, the legacy microgrid controller controls the tie flow to the contract demand maximum or minimum value. However, the legacy microgrid controller does not actively compensate to account for lags in the response of the sources. Also, the legacy microgrid controller expects adequate online sources to be always available to meet the power demand contract. A practical implementation should consider tolerances in control compared to the actual contract value to account for measurement errors between the microgrid controller's metering and measurements compared to the utility authority measurement. The legacy microgrid controller does not consider such tolerances. A practical product implementation may consider a demand setpoint value slightly away from the demand contract to account for tolerances. The embodiments disclosed herein may preemptively modify the setpoint further based on expected historical or recent load measurements to build more margin for response and get advantages in reducing the number of online sources at a site, by using the concept of excess and deficit energy demand computation introduced in this disclosure. For modifying the demand setpoint slightly, the decision factors are the cost of utility power compared to keeping more sources online and running at the site.

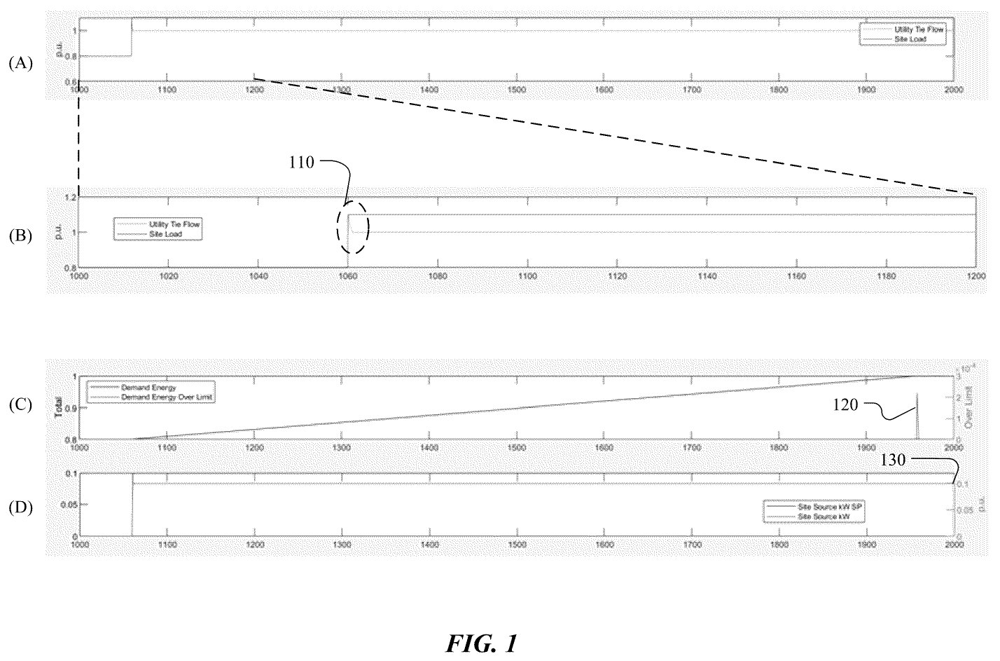

FIG. 1 illustrates an example handling of a load excursion by a legacy microgrid controller shown as a result of a simulation. In the example illustrated in FIG. 1, a demand interval is 15 minutes. The initial 900 seconds (15 minutes times 60 seconds) in the simulations are used to let the Demand Window Filter reach steady state. Thus, transients start beyond at 1060 seconds. In the example illustrated in FIG. 1, the maximum demand contract from the utility is 1.0 p.u. The site demand jumps from 0.8 p.u. to 1.1 p.u. at 1060 seconds. The site load of 1.1 p.u. may be within the site online power capacity (1.0 p.u. from utility+0.5 p.u. from site online source). (A) shows a comparison between power flow from the utility, which remains close to 1.0 p.u. from 1060 seconds, and site load, which jumps at 1060 seconds from 0.8 p.u. to 1.1 p.u. (B) shows a zoomed-in version of (A) from 1000 seconds to 1200 seconds. As can be seen within the outline 110, the power flow on the utility tie line goes up to 1.1 p.u. to serve the sudden load excursion at 1060 seconds until the site online source provides 0.1 p.u. The site online source such as a generator or an energy storage may be offline or have lags in their response due to ramps, communication and actuation delay. Thus, a little bit of time may be needed for the site online source to provide the power of 0.1 p.u. as shown in (D). Once the site online source becomes providing 0.1 p.u., the site online source maintains the steady power supply 130. Soon after 1060 seconds, the power flow on the utility tie line goes back to 1.0 p.u. and remains at the level. However, the power flow exceeding the maximum demand power contract shown in the outline 110 has not been compensated. (C) shows accumulated energy demand from 1060 seconds and energy demand over the maximum demand contract. The accumulated energy demand exceeds the maximum demand contract at around 1960 seconds 120 because the exceeding power flow in the outline 110 has not been compensated. This may result in a penalty from the utility. Although the illustrated example is with respect to a maximum demand, similar problem may also occur for a minimum demand case.

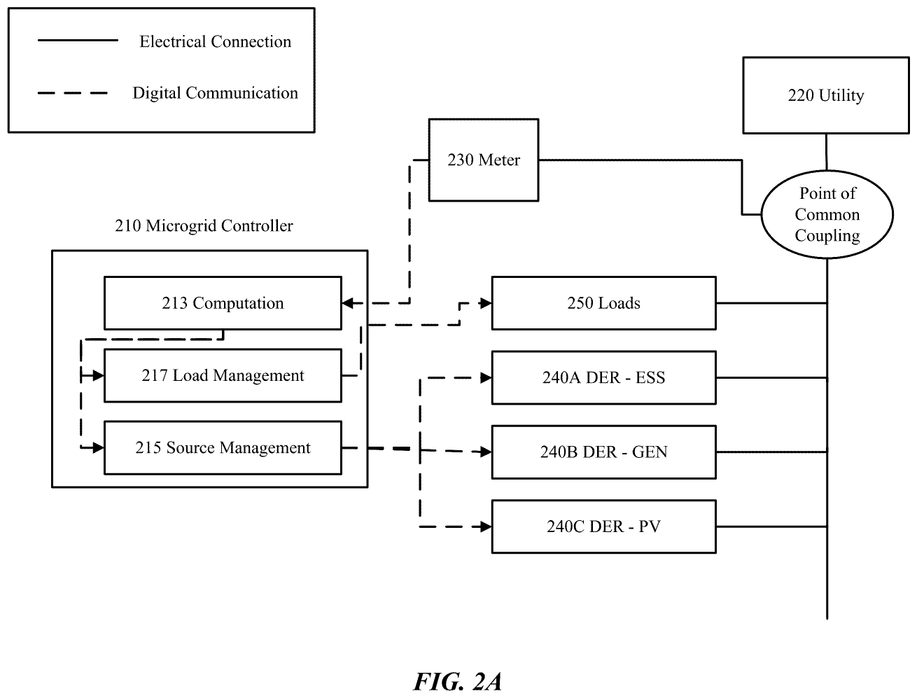

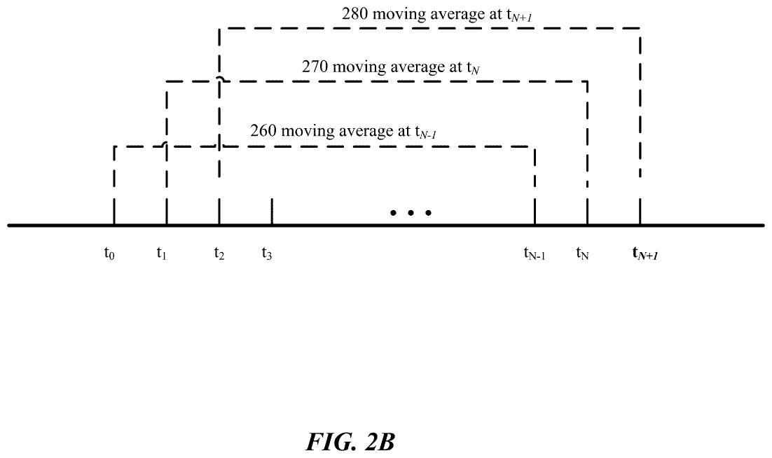

FIG. 2A illustrates an example logical architecture of a microgrid, in accordance with certain aspects of the present disclosure. A microgrid controller 210 may comprise a computation unit 213, a source management unit 215, and a load management unit 217. Utility 220 may provide power to a site. Additional distributed energy resources, including an energy storage system 240A, a generator 240B, and solar photovoltaics (PV) 240C, may also provide energy to the site as needed. Any other suitable distributed energy resources may be work as an energy source for the site. Even though FIG. 2 shows one block for loads 250, any number of energy consumers may exist in the site. The computation unit 213 may access measurements of power flow on a utility tic line measured by a meter 230 at a pre-determined sampling interval. In particular embodiments, the computation unit 213 may access measurements of power flow on the utility tie line measured within the microgrid controller 210. The computation unit 213 may detect an excess energy demand or a deficit energy demand in real-time. Upon detecting the excess energy demand or deficit energy demand, the computation unit 213 may instruct the source management unit 215 to adjust power setpoints accordingly. The source management unit 215 may adjust power setpoints for the distributed energy resources 240A, 240B, and 240C. In particular embodiments, the computation unit 213 may instruct the load management unit 217 to adjust loads of the site if allowable. In such a case, the load management unit 217 may control load of the loads 250. Although this disclosure describes a particular microgrid architecture, this disclosure contemplates any suitable microgrid architecture.

In particular embodiments, a system may access a measurement of power flow on a tic line performed at a pre-determined uniform interval. In particular embodiments, the measurement of power flow on the tie line may be performed by a microgrid controller. In particular embodiments, the measurement of power flow on the tie line may be performed by a meter outside a microgrid controller. As an example and not by way of limitation, the microgrid controller 210 may access measurements of power flow on the tie line from the utility 220 that are measured by the meter 230 at a uniform sample interval. As another example and not by way of limitation, the microgrid controller 210 may measure the power flow on the tie line from the utility 220 at the uniform sample interval. The accessed measurements may be forwarded to the computation unit 213. Although this disclosure describes accessing measurements of power flow on a utility tie line in a particular manner, this disclosure contemplates accessing measurements of power flow on a utility tie line in any suitable manner.

In particular embodiments, the system may calculate a moving average of the measured power flow over latest N measurements corresponding to a pre-determined amount of time. The pre-determined amount of time may be a demand interval. FIG. 2B illustrates example calculations of moving averages over N samples. At time t_{N-1}, the computation unit 213 may calculate a first moving average 260 using N measurements from t₀ to t_{N-1}. N is a number of measurements performed in a demand interval. In particular embodiments, the measurements may be performed at every 1 milli-second, 10 milli-seconds, 100 milli-seconds, 1 second, or any suitable measurement interval. For example, when a measurement interval is 1 second and a demand interval is 15 minutes, N would be 900. At time t_{N}, the computation unit 213 may calculate a second moving average 270 using N measurements from t₁ to t_{N}. Note that the second moving average 270 does not include the measurement performed at t₀. At time t_{N+1}, the computation unit 213 may calculate a third moving average 280 using N measurements from t₂ to t_{N+1}. Although this disclosure describes calculating a moving average of the measured power flow in a particular manner, this disclosure contemplates calculating a moving average of the measured power flow in any suitable manner.

In particular embodiments, the system may detect that a measurement of power flow exceeds a maximum power demand contract at a first time instance. The system may enter into an excess demand compensation mode in response to the detection that a measurement of power flow exceeds a maximum power demand contract at the first time instance. The system may control an excess energy demand to be zero during the excess demand compensation mode. The system may calculate the excess energy demand at a time instance after the first time instance based on measurements on or after the first time instance of power flow relative to the maximum power demand contract. The excess demand compensation mode may end when the excess energy demand becomes zero. The system may modify one or more power setpoints during the excess demand compensation mode to control the excess energy demand to be zero within the pre-determined amount of time from the first time instance. Although this disclosure describes adjusting one or more power setpoints during an excess demand compensation mode in a particular manner, this disclosure contemplates adjusting one or more power setpoints during an excess demand compensation mode in any suitable manner.

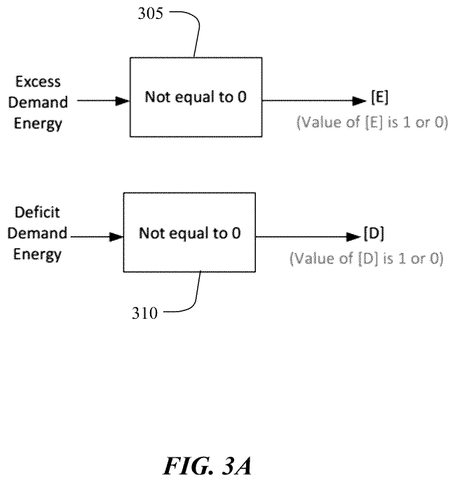

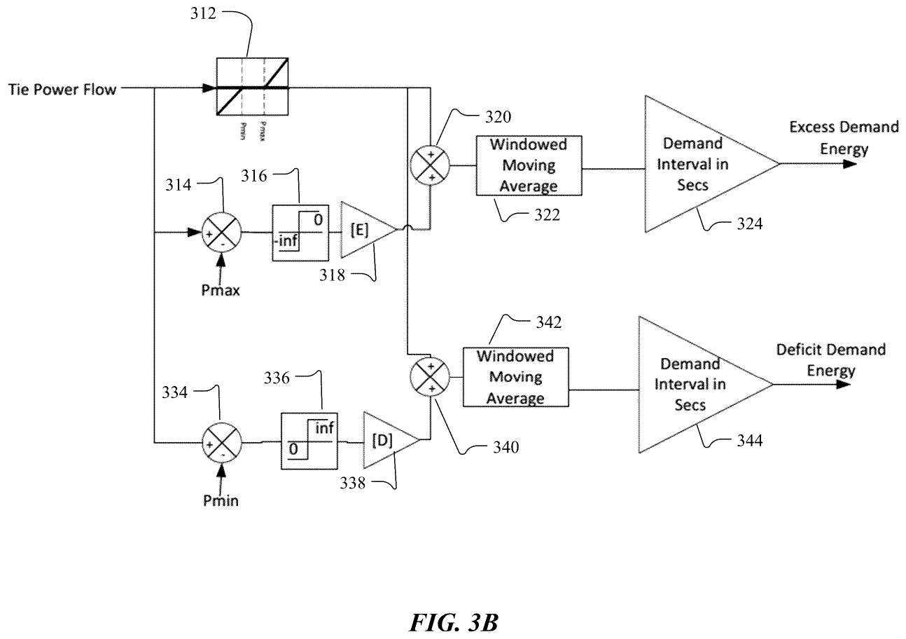

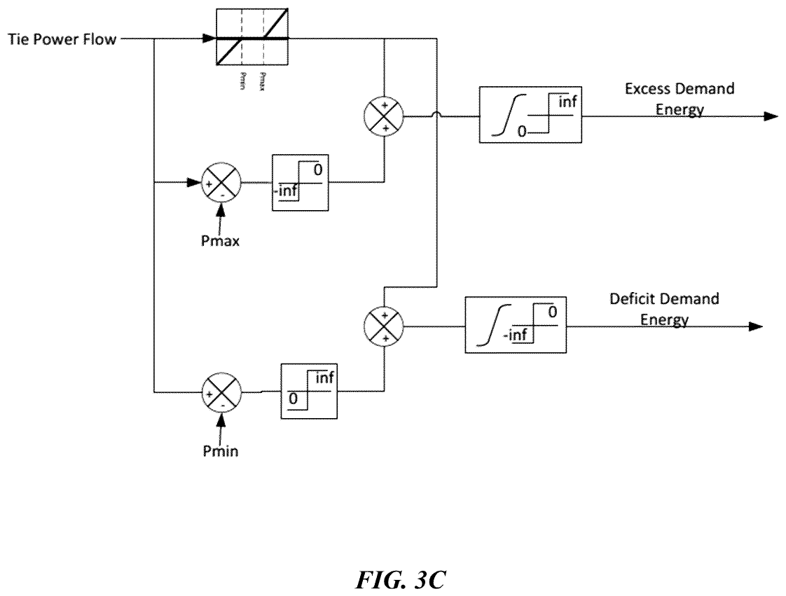

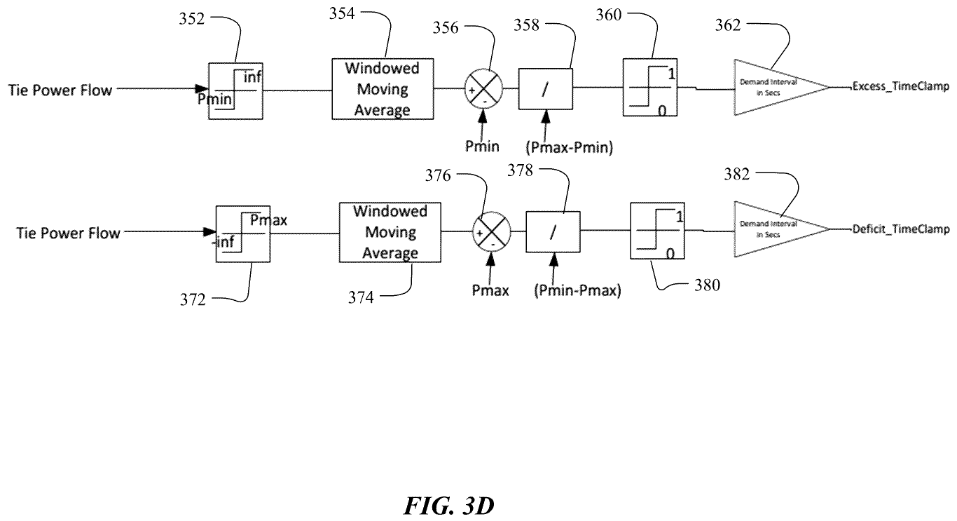

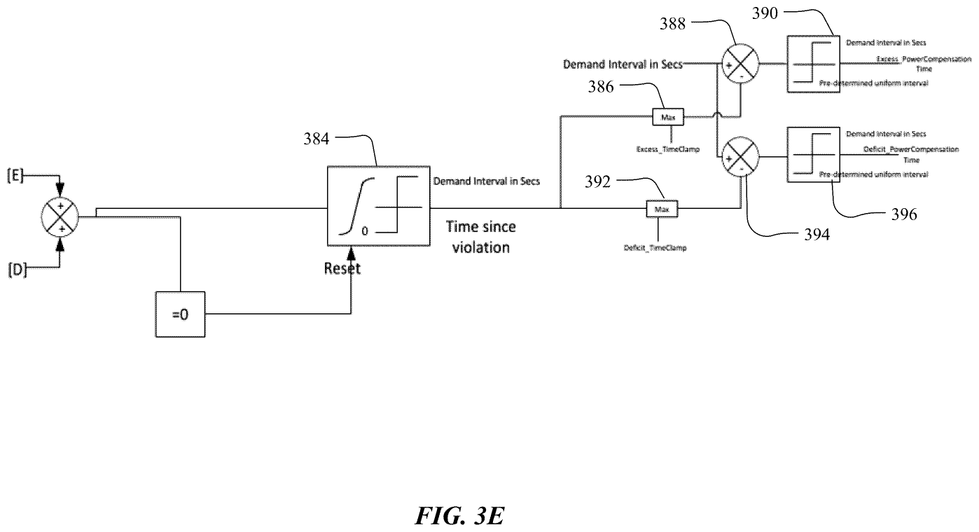

FIG. 3A illustrates example logics to determine an excess demand compensation mode and a deficit demand compensation mode. A first determination block 305 at the system may determine whether an excess energy demand calculated at a time instance is zero. If the calculated excess energy demand is zero, an excess energy compensation mode may be off. If the calculated excess energy demand is greater than zero, the excess energy compensation mode may be on. The system may enter into the excess energy compensation mode. Although this disclosure describes the first determination block 305 in a particular manner, this disclosure contemplates any suitable implementation of the first determination block 305.

In particular embodiments, to modify the one or more power setpoints, the system may calculate the excess energy demand at a second time instance by multiplying the pre-determined amount of time to a first moving window average of differences between the measurements on or after the first time instance and the maximum power demand contract at a second time instance. The second time instance may be later than the first time instance and within the pre-determined amount of time from the first time instance. The first moving window average may be calculated over latest N measurements at the second time instance. Measurements before the first time instance among the latest N measurements may be considered as zero. FIG. 3B illustrates particular example logics to calculate an excess energy demand and a deficit energy demand. A deadband 312 may produce zero when an input measurement of the tie power flow is between the minimum power demand contract and the maximum power demand contract. For input lower than the minimum power demand contract, the output of the deadband 312 may be the input minus the minimum power demand contract. For input higher than the maximum power demand contract, the output of the deadband 312 may be the input minus the maximum power demand contract. A first subtraction block 314 may calculate the input measurement of power flow—the maximum power demand contract. The output of the first subtraction block 314 may be provided to a first clamp 316 that may limit output to within and including negative infinite and zero. If an input to the first clamp 316 is greater than zero, the output will be zero. A first multiplication block 318 may multiply the output of the first clamp 316 with a binary indicator of the excess demand compensation mode calculated in FIG. 3A. Thus, when the excess demand compensation mode is off, the output of the first multiplication block 318 will be zero. A first adder 320 may add the output of the deadband 312 and the output of the first multiplication block 318. A first moving average calculation block 322 may compute a windowed moving average of the provided input. Measurements of the power flow during when the excess demand compensation mode is off would be considered as zero because of the first multiplication block 318. A second multiplication block 324 may multiply the windowed moving average with a time amount for a demand interval. The output of the second multiplication block 324 may be a value of an excess energy demand at a calculation time instance. Although this disclosure describes calculating an excess energy demand in a particular manner, this disclosure contemplates calculating an excess energy demand in any suitable manner. FIG. 3C illustrates alternative example logic to calculate an excess energy demand.

In particular embodiments, the system may access a time clamp value calculated based on a second moving window average at the first time instance of measurements of power flow greater than or equal to a minimum power demand contract. The time clamp value may be in between 0 and the pre-determined amount of time. FIG. 3D illustrates example logics to calculate an excess time clamp value and a deficit time clamp value. A second clamp 352 may limit output to within and including the minimum power demand contract and positive infinite. A second moving average calculation block 354 may compute a windowed moving average of the output of the second clamp 352. A second subtraction block 356 may calculate the windowed moving average computed by the second moving average calculation block 354 minus the minimum power demand contract. A first division block 358 may divide the output of the second subtraction block 356 by a span between the maximum power demand contract and the minimum power demand contract. The output of the first division block 358 may be processed by a third clamp 360 that limit output to within and including zero and one. The output of the third clamp 360 may be multiplied by the time amount corresponding to the demand interval at a multiplication block 362. Thus, an excess time clamp value may be between zero and the time amount corresponding to the demand interval. Although this disclosure describes calculating an excess time clamp in a particular manner, this disclosure contemplates calculating an excess time clamp in any suitable manner.

In particular embodiments, the system may calculate a power compensation time by subtracting a maximum among the time clamp value and an elapsed time since the first time instance from the pre-determined amount of time. FIG. 3E illustrates example logics to calculate an excess power compensation time and a deficit power compensation time. An integrator with a clamp 384 may accumulate time since the current excess demand compensation mode is on. A first maximum value determination block 386 may determine a maximum value among the output of the integrator 384 and the excess time clamp value computed in FIG. 3D. A third subtraction block 388 may subtract the output of the first maximum value determination block 386 from the amount of time corresponding to the demand interval. A fourth clamp 390 may limit output to within and including a time interval between measurements and the time amount corresponding to the demand interval. Although this disclosure describes calculating a power compensation time during when an excess demand compensation mode is on in a particular manner, this disclosure contemplates calculating a power compensation time during when an excess demand compensation mode is on in any suitable manner.

The system may add an estimated power compensation to a power setpoint for at least one online power generation source. The estimated power compensation may be computed by dividing the excess energy demand calculated at the second time instance by the power compensation time. Although this disclosure describes adding an estimated power compensation to a power setpoint to compensate an excess energy demand in a particular manner, this disclosure contemplates adding an estimated power compensation to a power setpoint to compensate an excess energy demand in any suitable manner.

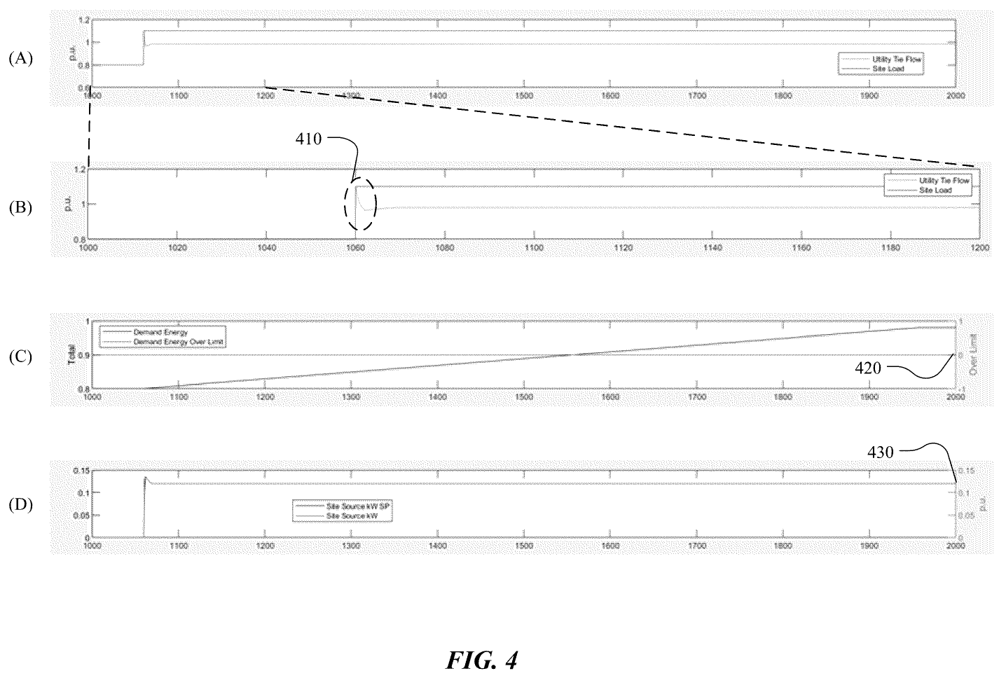

FIG. 4 illustrates an example handling of a load excursion, in accordance with certain aspects of the present disclosure. In the example illustrated in FIG. 4, an identical load excursion in the example illustrated in FIG. 1 occurs at time 1060 seconds. FIG. 4 shows how the microgrid controller 210 disclosed herein handles the load excursion to avoid a penalty caused by an excess energy demand. (A) shows a comparison between power flow from the utility and site load, which jumps at 1060 seconds from 0.8 p.u. to 1.1 p.u. as in the example illustrated in FIG. 1. (B) shows a zoomed-in version of (A) from 1000 seconds to 1200 seconds. The outlined area 410 shows that the power flow goes up briefly at 1060 seconds and goes down and remains steady. Though it is not clearly shown in (A) or (B), the steady power flow from 1060 seconds is a little bit below 1.0 p.u. because the excess energy demand caused by the burst around 1060 seconds is compensated throughout the demand interval. (D) shows power setpoints and power flow for the site online sources. As indicated at 430, the power flow from the site online sources is slightly above 0.1 p.u., which compensates the excess energy demand caused by the burst around 1060 seconds. (C) shows accumulated energy demand from 1060 seconds and energy demand over limit. As indicated by 420, energy demand over limit remains at zero.

In particular embodiments, the system may determine that a resulting power setpoint after adding the estimated power compensation exceeds a threshold of power capacity of the at least one online power generation source. In response to the determination, the system may enable at least one additional power generation source. The system may add a portion of the estimated power compensation to a power setpoint for the at least one additional power generation source. As an example and not by way of limitation, the computation unit 213 may determine that the capacity of the online distributed energy resources 240 may not be enough to compensate the excess energy demand caused by lags. The computation unit 213 may instruct the source management unit 215 to enable at least one additional distributed energy resources 240. After that, the computation unit 213 may instruct the source management unit 215 to add at least a portion of the estimated power compensation to a power setpoint of the enabled distributed energy resources 240. Although this disclosure describes enabling additional power sources when the system determines that the capacity of the online power sources is not enough to compensate the excess energy demand in a particular manner, this disclosure contemplates enabling additional power sources when the system determines that the capacity of the online power sources is not enough to compensate the excess energy demand in any suitable manner.

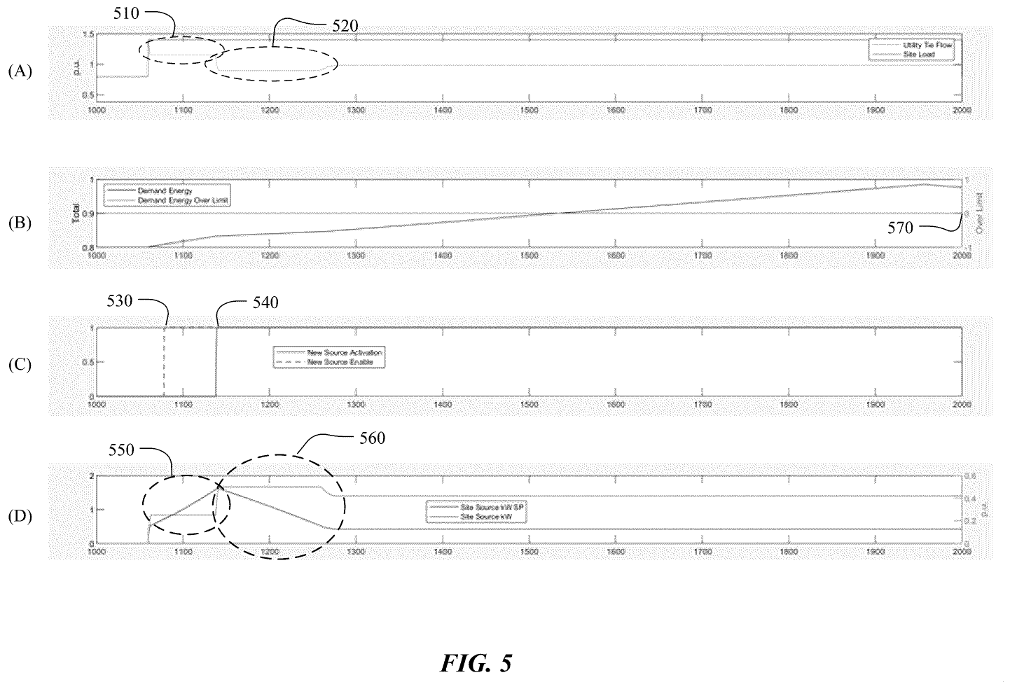

FIG. 5 illustrates another example handling of a load excursion, in accordance with certain aspects of the present disclosure. In the example illustrated in FIG. 5, the site energy demand jumps from 0.8 p.u. to 1.4 p.u. at 1060 seconds. The site online source capacity at the time of load excursion is 0.25 p.u. (A) shows a comparison between power flow from the utility and site load, which jumps at 1060 seconds from 0.8 p.u. to 1.4 p.u. (C) shows a time instance 530 at which the microgrid controller 210 enables one or more additional sources. The one or more additional sources are activated at time instance 540. The area 510 on (A) shows that the power flow from the utility stays higher than 1.0 p.u., which is the maximum demand power contract, for a while because the capacity of the site online sources is only 0.25 p.u. (D) shows power setpoint for the site online sources and power flow from the site online sources. Area 550 shows that the power setpoint keeps increasing because during that time period, excess energy demand keeps increasing. Figure shows the demand energy; the excess energy demand causes the energy demand to rise at a rate faster than 1.0 p.u./sec. Once the additional site online sources are activated at time instance 540, the power flow from the site online sources stays higher than 0.4 p.u. as shown in area 560. The area 560 also shows that the power setpoint is decreasing as the excess energy demand decreases. During that period, the power flow on the tie line from the utility stays lower than 1.0 p.u. in area 520 to compensate the excess demand energy. (B) shows accumulated demand energy from 1060 seconds and demand energy over limit; demand energy rises at a rate greater than 1.0 p.u./sec after 1060 seconds till area 540 where it settles back to 1.0 p.u./sec. As indicated by 570, demand energy over limit remains at zero.

In particular embodiments, to modify the one or more power setpoints to compensate the excess energy demand, the system may modify a power setpoint for at least one online power generation source from an initial value to a maximum capacity of the at least one online power generation source. The system may calculate an excess energy demand at each time instance accessing the measurement of the power flow on the tie line. The system may restore the power setpoint to the initial value when the calculated excess energy demand becomes zero. As an example and not by way of limitation, upon detecting an excess energy demand, the computation unit 213 may instruct the source management unit 215 to modify the power setpoints for online distributed energy resources 240 to their maximum capacities. The source management unit 215 may communicate with the online distributed energy resources 240 to provide the instructions. After that, the computation unit 213 keeps calculating the excess energy demand whenever the computation unit 213 accesses the measurement of power flow on the tie line from the utility 220. Once the computation unit 213 determines that the excess energy demand becomes zero. The computation unit 213 may instruct the source management unit 215 to restore the power setpoints for the online distributed energy resources 240 to the previous values. The source management unit 215 may communicate with the online distributed energy resources 240 to provide the instructions. Although this disclosure describes compensating an excess energy demand by setting power setpoints for online sources to their maximum capacities in a particular manner, this disclosure contemplates compensating an excess energy demand by setting power setpoints for online sources to their maximum capacities in any suitable manner.

In particular embodiments, the system may determine that modifying the power setpoint for at least one online power generation source to the maximum capacity of the at least one online power generation source is not enough to compensate the excess energy demand within the pre-determined amount of time from the first time instance. In response to the determination, the system may enable at least one additional power generation source. The system may modify a power setpoint for the at least one additional power generation source to a maximum capacity of the at least one additional power generation source. As an example and not by way of limitation, the computation unit 213 may determine that power flow from the online distributed energy resources at their maximum capacities would not be enough to compensate the detected excess energy demand. The computation unit 213 may instruct the source management unit 215 to enable at least one additional distributed energy resource 240. The source management unit 215 may communicate with the at least one additional distributed energy resource 240 to enable the distributed energy resource 240. The computation unit 213 may instruct the source management unit 215 to modify power setpoints for the online distributed energy resources 240 to their maximum capacity. The source management unit 215 may communicate with the online distributed energy resources 240 to provide instructions. After that, the computation unit 213 keeps calculating the excess energy demand whenever the computation unit 213 accesses the measurement of power flow on the tie line from the utility 220. Once the computation unit 213 determines that the excess energy demand becomes zero. The computation unit 213 may instruct the source management unit 215 to restore the power setpoints for the online distributed energy resources 240 to their previous values. The source management unit 215 may communicate with the online distributed energy resources 240 to provide the instructions. Although this disclosure describes enabling additional sources and set their power setpoints to their maximum capacities to compensate the detected excess energy demand in a particular manner, this disclosure contemplates enabling additional sources and set their power setpoints to their maximum capacities to compensate the detected excess energy demand in any suitable manner.

In particular embodiments, to modify the one or more power setpoints to compensate the excess energy demand, the system may modify a maximum demand setpoint to a value below the maximum demand power contract on the tie line. The system may calculate an excess energy demand at each time instance accessing the measurement of the power flow on the tie line. The system may restore the maximum demand setpoint to the maximum demand power contract on the tie line when the calculated excess energy demand becomes zero. Although this disclosure describes modifying a maximum demand setpoint to a value below the maximum demand power contract on the tie line to compensate the detected excess energy demand in a particular manner, this disclosure contemplates modifying a maximum demand setpoint to a value below the maximum demand power contract on the tie line to compensate the detected excess energy demand in any suitable manner.

In particular embodiments, the system may determine reducing loads at a site is allowed when the system detects that the calculated moving average exceeds the maximum demand power contract on the tie line. In response to the determination, the system may send instructions to reduce loads at the site. As an example and not by way of limitation, the computation unit 213 may detect an excess energy demand by calculating a moving average of the power flow on the tie line from the utility 220. The computation unit 213 may determine that reducing site loads is allowed. In response to the determination, the computation unit 213 may instruct the load management unit 217 to reduce site loads by a particular amount determined based on the excess energy demand. The load management unit 217 may communicate with the loads 250 to provide instructions. Although this disclosure describes reducing site loads upon detecting an excess energy demand in a particular manner, this disclosure contemplates reducing site loads upon detecting an excess energy demand in any suitable manner.

In particular embodiments, the system may access a measurement of power flow on the tie line performed at a pre-determined uniform interval. The system may calculate a moving average of the measured power flow over latest N measurements corresponding to a pre-determined amount of time. The pre-determined amount of time may be a demand interval. As an example and not by way of limitation, the microgrid controller 210 may access measurements of power flow on the tie line from the utility 220 that are measured by the meter 230 at a uniform sample interval. As another example and not by way of limitation, the microgrid controller 210 may measure the power flow on the tie line from the utility 220 at the uniform sample interval. The accessed measurements may be forwarded to the computation unit 213. Although this disclosure describes accessing measurements of power flow on a utility tie line in a particular manner, this disclosure contemplates accessing measurements of power flow on a utility tie line in any suitable manner.

In particular embodiments, the system may detect that a measurement of power flow falls below a minimum power demand contract at a first time instance. The system may enter into a deficit demand compensation mode in response to the detection that a measurement of power flow falls below a minimum power demand contract. The system may control a deficit energy demand to be zero during the deficit demand compensation mode. The system may calculate the deficit energy demand at a time instance after the first time instance based on measurements on or after the first time instance of power flow relative to the minimum power demand contract until the deficit energy demand becomes zero. The deficit demand compensation mode may end when the deficit energy demand becomes zero. The system may modify one or more power setpoints during the deficit demand compensation mode to control the deficit energy demand to be zero within the pre-determined amount of time from the first time instance. Although this disclosure describes adjusting one or more power setpoints during a deficit demand compensation mode is on in a particular manner, this disclosure contemplates adjusting one or more power setpoints during a deficit demand compensation mode is on in any suitable manner.

FIG. 3A illustrates example logics to determine an excess demand compensation mode and a deficit demand compensation mode. A second determination block 310 at the system may determine whether a deficit energy demand calculated at a time instance is zero. If the calculated deficit energy demand is zero, a deficit energy compensation mode may be off. If the calculated deficit energy demand is not equal to zero, the deficit energy compensation mode may be on. The system may enter into the deficit energy compensation mode. Although this disclosure describes the second determination block 310 in a particular manner, this disclosure contemplates any suitable implementation of the second determination block 310.

In particular embodiments, to modify the one or more power setpoints, the system may calculate the deficit energy demand at a second time instance by multiplying the pre-determined amount of time to a first moving window average of differences between the measurements on or after the first time instance and the minimum power demand contract. The second time instance may be later than the first time instance and within the pre-determined amount of time from the first time instance. The first moving window average may be calculated over latest N measurements at the second time instance. Measurements before the first time instance among the latest N measurements may be considered as zero. FIG. 3B illustrates particular example logics to calculate an excess energy demand and a deficit energy demand. A deadband 312 may produce zero when an input measurement of the tie power flow is between the minimum power demand contract and the maximum power demand contract. For input lower than the minimum power demand contract, the output of the deadband 312 may be the input minus the minimum power demand contract. For input higher than the maximum power demand contract, the output of the deadband 312 may be the input minus the maximum power demand contract. A fourth subtraction block 334 may calculate the input measurement of power flow—the minimum power demand contract. The output of the fourth subtraction block 334 may be provided to a fifth clamp 336 that may limit output to within and including zero and positive infinite. If an input to the fifth clamp 336 is less than zero, the output will be zero. A third multiplication block 338 may multiply the output of the fifth clamp 336 with a binary indicator of the deficit demand compensation mode calculated in FIG. 3A. Thus, when the deficit demand compensation mode is off, the output of the third multiplication block 338 will be zero. A second adder 340 may add the output of the deadband 312 and the output of the third multiplication block 338. A third moving average calculation block 342 may compute a windowed moving average of the provided input. Measurements of the power flow during when the deficit demand compensation mode is off would be considered as zero because of the third multiplication block 338. A fourth multiplication block 344 may multiply the windowed moving average with a time amount for a demand interval. The output of the fourth multiplication block 344 may be a value of a deficit energy demand at a calculation time instance. Although this disclosure describes calculating a deficit energy demand in a particular manner, this disclosure contemplates calculating a deficit energy demand in any suitable manner. FIG. 3C illustrates alternative example logic to calculate a deficit energy demand.

In particular embodiments, the system may access a time clamp value calculated based on a second moving window average at the first time of measurements of power flow less than or equal to a maximum power demand contract. The time clamp value may be in between 0 and the pre-determined amount of time. FIG. 3D illustrates example logics to calculate an excess time clamp value and a deficit time clamp value. A sixth clamp 372 may limit output to within and including negative infinite and the maximum power demand contract. A fourth moving average calculation block 374 may compute a windowed moving average of the output of the sixth clamp 372. A fifth subtraction block 376 may calculate the windowed moving average computed by the fourth moving average calculation block 374 minus the maximum power demand contract. A second division block 378 may divide the output of the fifth subtraction block 376 by a negative span between the minimum power demand contract and the maximum power demand contract. The output of the second division block 378 may be processed by a seventh clamp 380 that limit output to within and including zero and one. The output of the seventh clamp 380 may be multiplied by the time amount corresponding to the demand interval at a multiplication block 382. Thus, a deficit time clamp value may be between zero and the time amount corresponding to the demand interval. Although this disclosure describes calculating a deficit time clamp in a particular manner, this disclosure contemplates calculating a deficit time clamp in any suitable manner.

In particular embodiments, the system may calculate a power compensation time by subtracting a maximum among the time clamp value and an elapsed time since the first time instance from the pre-determined amount of time. FIG. 3E illustrates example logics to calculate an excess power compensation time and a deficit power compensation time. An integrator with a clamp 384 may accumulate time since the current deficit demand compensation mode is on. A second maximum value determination block 392 may determine a maximum value among the output of the integrator 384 and the deficit time clamp value computed in FIG. 3D. A sixth subtraction block 394 may subtract the output of the second maximum value determination block 392 from the amount of time corresponding to the demand interval. An eighth clamp 396 may limit output to within and including a time interval between measurements and the time amount corresponding to the demand interval. Although this disclosure describes calculating a power compensation time during when a deficit demand compensation mode is on in a particular manner, this disclosure contemplates calculating a power compensation time during when a deficit demand compensation mode is on in any suitable manner.

In particular embodiments, the system may subtract an estimated power compensation from a power setpoint for at least one online power generation source. The estimated power compensation may be computed by dividing the deficit energy demand at the second time instance by the power compensation time. Although this disclosure describes subtracting an estimated power compensation from a power setpoint to compensate a deficit energy demand in a particular manner, this disclosure contemplates subtracting an estimated power compensation from a power setpoint to compensate a deficit energy demand in any suitable manner.

In particular embodiments, to modify the one or more power setpoints to compensate the deficit energy demand, the system may modify a power setpoint for at least one online power generation source from an initial value to a minimum capacity of the at least one online power generation source. The system may calculate a deficit energy demand at each time instance accessing the measurement of the power flow on the tie line. The system may restore the power setpoint to the initial value when the calculated deficit energy demand becomes zero. As an example and not by way of limitation, upon detecting a deficit energy demand, the computation unit 213 may instruct the source management unit 215 to modify the power setpoints for online distributed energy resources 240 to their minimum capacities. The source management unit 215 may communicate with the online distributed energy resources 240 to provide the instructions. After that, the computation unit 213 keeps calculating the deficit energy demand whenever the computation unit 213 accesses the measurement of power flow on the tie line from the utility 220. Once the computation unit 213 determines that the deficit energy demand becomes zero. The computation unit 213 may instruct the source management unit 215 to restore the power setpoints for the online distributed energy resources 240 to their previous values. The source management unit 215 may communicate with the online distributed energy resources 240 to provide the instructions. Although this disclosure describes compensating a deficit energy demand by setting power setpoints for online sources to their minimum capacities in a particular manner, this disclosure contemplates compensating a deficit energy demand by setting power setpoints for online sources to their minimum capacities in any suitable manner.

In particular embodiments, to modify the one or more power setpoints to compensate the deficit energy demand, the system may modify a minimum demand setpoint to a value above the minimum demand power contract on the tie line. The system may calculate an excess energy demand at each time instance accessing the measurement of the power flow on the tie line. The system may restore the minimum demand setpoint to the minimum demand power contract on the tie line when the calculated deficit energy demand becomes zero. Although this disclosure describes modifying a minimum demand setpoint to a value above the minimum demand power contract to compensate a deficit energy demand in a particular manner, this disclosure contemplates modifying a minimum demand setpoint to a value above the minimum demand power contract to compensate a deficit energy demand in any suitable manner.

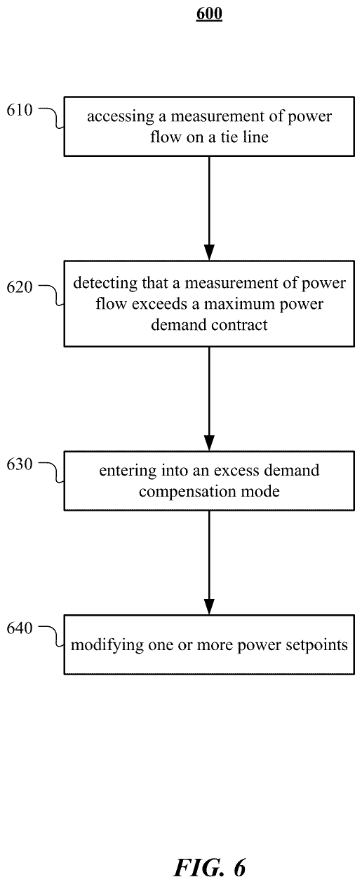

FIG. 6 illustrates an example method 600 for compensating an excess energy demand by modifying power setpoints. The method may begin at step 610, where a system may access a measurement of power flow on a tie line performed at a pre-determined uniform interval. At step 620, the system may detect that a measurement of power flow exceeds a maximum power demand contract at a first time instance. At step 630, the system may enter into an excess demand compensation mode in response to the detection that a measurement of power flow exceeds a maximum power demand contract. The system may control an excess energy demand to be zero during the excess demand compensation mode. The excess energy demand at a time instance after the first time instance may be calculated based on measurements on or after the first time instance of power flow relative to the maximum power demand contract until the excess energy demand becomes zero. At step 640, the system may modify one or more power setpoints during the excess demand compensation mode to control the excess energy demand to be zero within the pre-determined amount of time from the first time instance. Particular embodiments may repeat one or more steps of the method of FIG. 6, where appropriate. Although this disclosure describes and illustrates particular steps of the method of FIG. 6 as occurring in a particular order, this disclosure contemplates any suitable steps of the method of FIG. 6 occurring in any suitable order. Moreover, although this disclosure describes and illustrates an example method for compensating an excess energy demand by modifying power setpoints including the particular steps of the method of FIG. 6, this disclosure contemplates any suitable method for compensating an excess energy demand by modifying power setpoints including any suitable steps, which may include all, some, or none of the steps of the method of FIG. 6, where appropriate. Furthermore, although this disclosure describes and illustrates particular components, devices, or systems carrying out particular steps of the method of FIG. 6, this disclosure contemplates any suitable combination of any suitable components, devices, or systems carrying out any suitable steps of the method of FIG. 6.

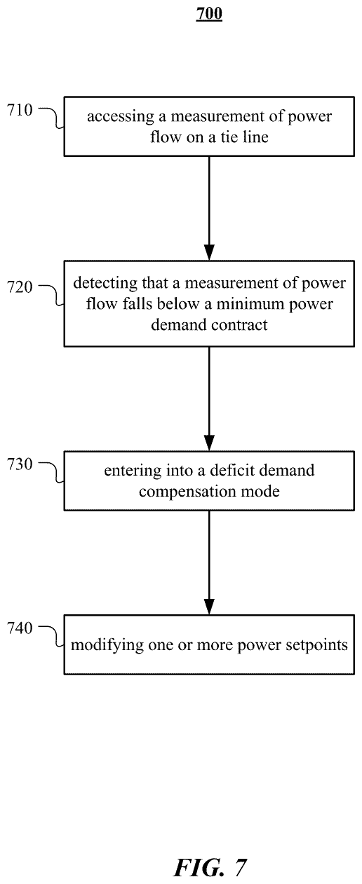

FIG. 7 illustrates an example method 700 for compensating a deficit energy demand by modifying power setpoints. The method may begin at step 710, where a system may access a measurement of power flow on a tie line performed at a pre-determined uniform interval. At step 720, the system may detect that a measurement of power flow falls below a minimum power demand contract at a first time instance. At step 730, the system may enter into a deficit demand compensation mode in response to the detection that a measurement of power flow falls below a minimum power demand contract. The system may control a deficit energy demand to be zero during the deficit demand compensation mode. The deficit energy demand at a time instance after the first time instance is calculated based on measurements on or after the first time instance of power flow relative to the minimum power demand contract until the deficit energy demand becomes zero. At step 740, the system may modify one or more power setpoints during the deficit demand compensation mode to control the deficit energy demand to be zero within the pre-determined amount of time from the first time instance. Particular embodiments may repeat one or more steps of the method of FIG. 7, where appropriate. Although this disclosure describes and illustrates particular steps of the method of FIG. 7 as occurring in a particular order, this disclosure contemplates any suitable steps of the method of FIG. 7 occurring in any suitable order. Moreover, although this disclosure describes and illustrates an example method for compensating a deficit energy demand by modifying power setpoints including the particular steps of the method of FIG. 7, this disclosure contemplates any suitable method for compensating a deficit energy demand by modifying power setpoints including any suitable steps, which may include all, some, or none of the steps of the method of FIG. 7, where appropriate. Furthermore, although this disclosure describes and illustrates particular components, devices, or systems carrying out particular steps of the method of FIG. 7, this disclosure contemplates any suitable combination of any suitable components, devices, or systems carrying out any suitable steps of the method of FIG. 7.

### Systems and Methods

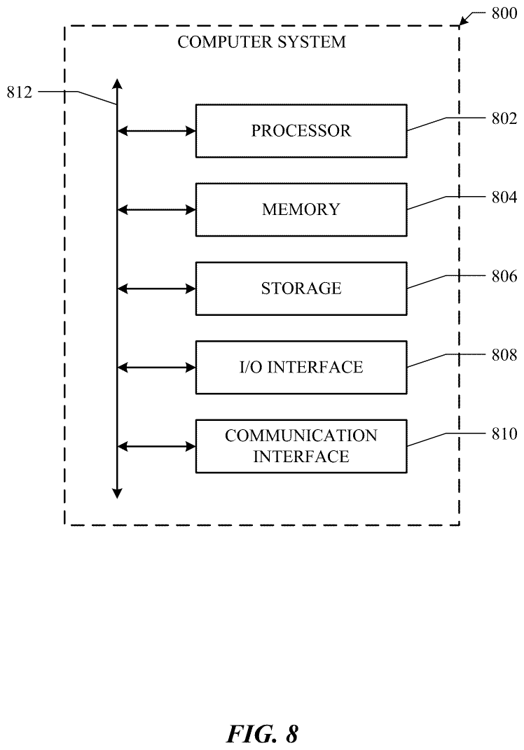

FIG. 8 illustrates an example computer system 800. In particular embodiments, one or more computer systems 800 perform one or more steps of one or more methods described or illustrated herein. In particular embodiments, one or more computer systems 800 provide functionality described or illustrated herein. In particular embodiments, software running on one or more computer systems 800 performs one or more steps of one or more methods described or illustrated herein or provides functionality described or illustrated herein. Particular embodiments include one or more portions of one or more computer systems 800. Herein, reference to a computer system may encompass a computing device, and vice versa, where appropriate. Moreover, reference to a computer system may encompass one or more computer systems, where appropriate.

This disclosure contemplates any suitable number of computer systems 800. This disclosure contemplates computer system 800 taking any suitable physical form. As example and not by way of limitation, computer system 800 may be an embedded computer system, a system-on-chip (SOC), a programmable logic controller (PLC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 800 may include one or more computer systems 800; be unitary or distributed; span multiple locations; span multiple machines; span multiple data centers; or reside in a cloud, which may include one or more cloud components in one or more networks. Where appropriate, one or more computer systems 800 may perform without substantial spatial or temporal limitation one or more steps of one or more methods described or illustrated herein. As an example and not by way of limitation, one or more computer systems 800 may perform in real time or in batch mode one or more steps of one or more methods described or illustrated herein. One or more computer systems 800 may perform at different times or at different locations one or more steps of one or more methods described or illustrated herein, where appropriate.

In particular embodiments, computer system 800 includes a processor 802, memory 804, storage 806, an input/output (I/O) interface 808, a communication interface 810, and a bus 812. Although this disclosure describes and illustrates a particular computer system having a particular number of particular components in a particular arrangement, this disclosure contemplates any suitable computer system having any suitable number of any suitable components in any suitable arrangement.

In particular embodiments, processor 802 includes hardware for executing instructions, such as those making up a computer program. As an example and not by way of limitation, to execute instructions, processor 802 may retrieve (or fetch) the instructions from an internal register, an internal cache, memory 804, or storage 806; decode and execute them; and then write one or more results to an internal register, an internal cache, memory 804, or storage 806. In particular embodiments, processor 802 may include one or more internal caches for data, instructions, or addresses. This disclosure contemplates processor 802 including any suitable number of any suitable internal caches, where appropriate. As an example and not by way of limitation, processor 802 may include one or more instruction caches, one or more data caches, and one or more translation lookaside buffers (TLBs). Instructions in the instruction caches may be copies of instructions in memory 804 or storage 806, and the instruction caches may speed up retrieval of those instructions by processor 802. Data in the data caches may be copies of data in memory 804 or storage 806 for instructions executing at processor 802 to operate on; the results of previous instructions executed at processor 802 for access by subsequent instructions executing at processor 802 or for writing to memory 804 or storage 806; or other suitable data. The data caches may speed up read or write operations by processor 802. The TLBs may speed up virtual-address translation for processor 802. In particular embodiments, processor 802 may include one or more internal registers for data, instructions, or addresses. This disclosure contemplates processor 802 including any suitable number of any suitable internal registers, where appropriate. Where appropriate, processor 802 may include one or more arithmetic logic units (ALUs); be a multi-core processor; or include one or more processors 802. Although this disclosure describes and illustrates a particular processor, this disclosure contemplates any suitable processor.

In particular embodiments, memory 804 includes main memory for storing instructions for processor 802 to execute or data for processor 802 to operate on. As an example and not by way of limitation, computer system 800 may load instructions from storage 806 or another source (such as, for example, another computer system 800) to memory 804. Processor 802 may then load the instructions from memory 804 to an internal register or internal cache. To execute the instructions, processor 802 may retrieve the instructions from the internal register or internal cache and decode them. During or after execution of the instructions, processor 802 may write one or more results (which may be intermediate or final results) to the internal register or internal cache. Processor 802 may then write one or more of those results to memory 804. In particular embodiments, processor 802 executes only instructions in one or more internal registers or internal caches or in memory 804 (as opposed to storage 806 or elsewhere) and operates only on data in one or more internal registers or internal caches or in memory 804 (as opposed to storage 806 or elsewhere). One or more memory buses (which may each include an address bus and a data bus) may couple processor 802 to memory 804. Bus 812 may include one or more memory buses, as described below. In particular embodiments, one or more memory management units (MMUs) reside between processor 802 and memory 804 and facilitate accesses to memory 804 requested by processor 802. In particular embodiments, memory 804 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 804 may include one or more memories 804, where appropriate. Although this disclosure describes and illustrates particular memory, this disclosure contemplates any suitable memory.

In particular embodiments, storage 806 includes mass storage for data or instructions. As an example and not by way of limitation, storage 806 may include a hard disk drive (HDD), a floppy disk drive, flash memory, an optical disc, a magneto-optical disc, magnetic tape, or a Universal Serial Bus (USB) drive or a combination of two or more of these. Storage 806 may include removable or non-removable (or fixed) media, where appropriate. Storage 806 may be internal or external to computer system 800, where appropriate. In particular embodiments, storage 806 is non-volatile, solid-state memory. In particular embodiments, storage 806 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 806 taking any suitable physical form. Storage 806 may include one or more storage control units facilitating communication between processor 802 and storage 806, where appropriate. Where appropriate, storage 806 may include one or more storages 806. Although this disclosure describes and illustrates particular storage, this disclosure contemplates any suitable storage.

In particular embodiments, I/O interface 808 includes hardware, software, or both, providing one or more interfaces for communication between computer system 800 and one or more I/O devices. Computer system 800 may include one or more of these I/O devices, where appropriate. One or more of these I/O devices may enable communication between a person and computer system 800. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 808 for them. Where appropriate, I/O interface 808 may include one or more device or software drivers enabling processor 802 to drive one or more of these I/O devices. I/O interface 808 may include one or more I/O interfaces 808, where appropriate. Although this disclosure describes and illustrates a particular I/O interface, this disclosure contemplates any suitable I/O interface.

In particular embodiments, communication interface 810 includes hardware, software, or both providing one or more interfaces for communication (such as, for example, packet-based communication) between computer system 800 and one or more other computer systems 800 or one or more networks. As an example and not by way of limitation, communication interface 810 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 810 for it. As an example and not by way of limitation, computer system 800 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 800 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 800 may include any suitable communication interface 810 for any of these networks, where appropriate. Communication interface 810 may include one or more communication interfaces 810, where appropriate. Although this disclosure describes and illustrates a particular communication interface, this disclosure contemplates any suitable communication interface.

In particular embodiments, bus 812 includes hardware, software, or both coupling components of computer system 800 to each other. As an example and not by way of limitation, bus 812 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 812 may include one or more buses 812, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising:
accessing a measurement of power flow on a tie line performed at a pre-determined uniform interval;
detecting, at a first time instance, that a measurement of power flow exceeds a maximum power demand contract;
entering, in response to the detection, into an excess demand compensation mode, wherein an excess energy demand is controlled to be zero during the excess demand compensation mode, and wherein the excess energy demand at a time instance after the first time instance is calculated based on measurements on or after the first time instance of power flow relative to the maximum power demand contract until the excess energy demand becomes zero; and
modifying, during the excess demand compensation mode, one or more power setpoints to control the excess energy demand to be zero within the pre-determined amount of time from the first time instance.

2. The method of claim 1, wherein modifying the one or more power setpoints comprises:
calculating, at a second time instance, the excess energy demand by multiplying the pre-determined amount of time to a first moving window average of differences between the measurements on or after the first time instance and the maximum power demand contract, wherein the first moving window average is calculated over latest N measurements at the second time instance, and wherein measurements before the first time instance among the latest N measurements are considered as zero;
accessing a time clamp value calculated based on a second moving window average at the first time instance of measurements of power flow greater than or equal to a minimum power demand contract, wherein the time clamp value is in between 0 and the pre-determined amount of time;
calculating a power compensation time by subtracting a maximum among the time clamp value and an elapsed time since the first time instance from the pre-determined amount of time; and
adding an estimated power compensation to a power setpoint for at least one online power generation source, wherein the estimated power compensation is computed by dividing the excess energy demand calculated at the second time instance by the power compensation time.

3. The method of claim 2, further comprising:
determining that a resulting power setpoint after adding the estimated power compensation exceeds a threshold of power capacity of the at least one online power generation source;
enabling, in response to the determination, at least one additional power generation source; and
adding a portion of the estimated power compensation to a power setpoint for the at least one additional power generation source.

4. The method of claim 1, wherein modifying the one or more power setpoints comprises:
modifying a power setpoint for at least one online power generation source from an initial value to a maximum capacity of the at least one online power generation source;
calculating, at each time instance accessing the measurement of the power flow on the tie line, an excess energy demand at the time instance; and
restoring the power setpoint to the initial value when the calculated excess energy demand becomes zero.

5. The method of claim 4, further comprising:
determining that modifying the power setpoint for at least one online power generation source to the maximum capacity of the at least one online power generation source is not enough to compensate the excess energy demand within the pre-determined amount of time from the first time instance;
enabling, in response to the determination, at least one additional power generation source; and
modifying a power setpoint for the at least one additional power generation source to a maximum capacity of the at least one additional power generation source.

6. The method of claim 1, wherein modifying the power setpoint comprises:
modifying a maximum demand setpoint to a value below the maximum demand power contract on the tie line;
calculating, at each time instance accessing the measurement of the power flow on the tie line, an excess energy demand at the time instance; and
restoring the maximum demand setpoint to the maximum demand power contract on the tie line when the calculated excess energy demand becomes zero.

7. The method of claim 1, wherein the excess demand compensation mode ends when the excess energy demand becomes zero.

8. The method of claim 1, wherein the pre-determined amount of time is a demand interval, and wherein a penalty is charged when an accumulation of power flow on the tie line over a demand interval exceeds the maximum demand contract.

9. The method of claim 1, wherein the measurement of power flow on the tie line is performed by a microgrid controller.

10. The method of claim 1, wherein the measurement of power flow on the tie line is performed by a meter outside a microgrid controller.

11. The method of claim 1, further comprising:
determining, in response to the detection, reducing loads at a site is allowed; and
sending, in response to the determination, instructions to reduce loads at the site.

12. A method comprising:
accessing a measurement of power flow on a tie line performed at a pre-determined uniform interval;
detecting, at a first time instance, that a measurement of power flow falls below a minimum power demand contract;
entering, in response to the detection, into a deficit demand compensation mode, wherein a deficit energy demand is controlled to be zero during the deficit demand compensation mode, and wherein the deficit energy demand at a time instance after the first time instance is calculated based on measurements on or after the first time instance of power flow relative to the minimum power demand contract until the deficit energy demand becomes zero; and
modifying, during the deficit demand compensation mode, one or more power setpoints to control the deficit energy demand to be zero within the pre-determined amount of time from the first time instance.

13. The method of claim 12, wherein modifying the one or more power setpoints comprises:
calculating, at a second time instance, the deficit energy demand by multiplying the pre-determined amount of time to a first moving window average of differences between the measurements on or after the first time instance and the minimum power demand contract, wherein the first moving window average is calculated over latest N measurements at the second time instance, and wherein measurements before the first time instance among the latest N measurements are considered as zero;
accessing a time clamp value calculated based on a second moving window average at the first time instance of measurements of power flow less than or equal to a maximum power demand contract, wherein the time clamp value is in between 0 and the pre-determined amount of time;
calculating a power compensation time by subtracting a maximum among the time clamp value and an elapsed time since the first time instance from the pre-determined amount of time; and
subtracting an estimated power compensation from a power setpoint for at least one online power generation source, wherein the estimated power compensation is computed by dividing the deficit energy demand at the second time instance by the power compensation time.

14. The method of claim 12, wherein modifying the one or more power setpoints comprises:
modifying a power setpoint for at least one online power generation source from an initial value to a minimum capacity of the at least one online power generation source;
calculating, at each time instance accessing the measurement of the power flow on the tie line, a deficit energy demand at the time instance; and
restoring the power setpoint to the initial value when the calculated deficit energy demand becomes zero.

15. The method of claim 12, wherein modifying the power setpoint comprises:
modifying a minimum demand setpoint to a value above the minimum demand power contract on the tie line;
calculating, at each time instance accessing the measurement of the power flow on the tie line, a deficit energy demand at the time instance; and
restoring the minimum demand setpoint to the minimum demand power contract on the tie line when the calculated deficit energy demand becomes zero.

16. The method of claim 12, wherein the pre-determined amount of time is a demand interval, and wherein a penalty is charged when an accumulation of power flow on the tie line over a demand interval falls below the minimum demand contract.

17. The method of claim 12, wherein the deficit demand compensation mode ends when the deficit energy demand becomes zero.

18. A system comprising:
one or more processors; and
one or more computer-readable non-transitory storage media coupled to one or more of the processors and comprising instructions operable when executed by one or more of the processors to cause the system to perform operations comprising:
accessing a measurement of power flow on a tie line performed at a pre-determined uniform interval;
detecting, at a first time instance, that a measurement of power flow exceeds a maximum power demand contract;
entering, in response to the detection, into an excess demand compensation mode, wherein an excess energy demand is controlled to be less than or equal to zero during the excess demand compensation mode, and wherein the excess energy demand at a time instance after the first time instance is calculated based on measurements of power flow on or after the first time instance relative to the maximum power demand contract until the excess energy demand becomes zero; and
modifying, during the excess demand compensation mode, one or more power setpoints to control the excess energy demand to be zero within the pre-determined amount of time from the first time instance.

19. The system of claim 18, wherein modifying the one or more power setpoints comprises:
calculating, at a second time instance, the excess energy demand by multiplying the pre-determined amount of time to a first moving window average of differences between the measurements on or after the first time instance and the maximum power demand contract, wherein the first moving window average is calculated over latest N measurements from the second time instance, and wherein measurements before the first time instance among the latest N measurements are considered as zero;
calculating a time clamp value based on a second moving window average calculated at the first time instance of measurements of power flow greater than or equal to a minimum power demand contract, wherein the time clamp value is in between 0 and the pre-determined amount of time;
calculating a power compensation time by subtracting a maximum among the time clamp value and an elapsed time since the first time instance from the pre-determined amount of time; and
adding an estimated power compensation to a power setpoint for at least one online power generation source, wherein the estimated power compensation is computed by dividing the excess energy demand calculated at the second time instance by the power compensation time.

20. The system of claim 18, wherein modifying the one or more power setpoints comprises:
modifying a power setpoint for at least one online power generation source from an initial value to a maximum capacity of the at least one online power generation source;
calculating, at each time instance accessing the measurement of the power flow on the tie line, an excess energy demand at the time instance; and
restoring the power setpoint to the initial value when the calculated excess energy demand becomes zero.
